(19) United States
(12) Patent Application Publication
(10) Pub. No.: US 2025/0218615 A1
(43) Pub. Date: Jul. 3, 2025

(54) RADIATION SHIELDING COMPOSITES

(71) Applicant: Bridgestone Corporation, Tokyo (JP)

(72) Inventor: Mindaugas RACKAITIS, Hudson, OH (US)

(21) Appl. No.: 19/004,633

(22) Filed: Dec. 30, 2024

Related U.S. Application Data
(60) Provisional application No. 63/615,324, filed on Dec. 28, 2023.

(51) Int. Cl. G21F 1/10; B29C 48/00; B29C 48/21; B29K 9/00; B29K 25/00; B29K 105/12; B29K 105/24; B29K 505/04; B29K 505/06; B29K 505/10; B29K 505/14; B29K 507/04; B29K 509/08; B29L 9/00; B29L 31/00; G21F 1/08

(52) U.S. Cl. CPC G21F 1/106; B29C 48/023; B29C 48/21; G21F 1/085; B29K 2009/00; B29K 2023/06; B29K 2025/06; B29K 2105/12; B29K 2105/24; B29K 2505/04; B29K 2505/06; B29K 2505/10; B29K 2505/14; B29K 2507/04; B29K 2509/08; B29L 2009/00; B29L 2031/768

(57) ABSTRACT

A radiation shielding composite comprising a first component including a copolymer including unconjugated olefin-derived units, vinyl aromatic-derived units, and conjugated diene-derived units; and a second component including a radiation-shielding metal.

### CROSS REFERENCE TO RELATED APPLICATIONS

This application claims the benefit of U.S. Provisional Patent Application Ser. No. 63/615,324 filed on Dec. 28, 2023, and incorporated herein by reference in its entirety.

### FIELD OF THE INVENTION

One or more embodiments of the present invention relates to radiation shielding composites including layered structures of ethylene-diene copolymers and eutectic metal alloys.

### BACKGROUND OF THE INVENTION

Preserving both human safety and materials that may be compromised by radiation exposure is a vital concern. The process of regulating the effects and degree of penetration of radioactive rays varies according to the type of radiation involved. Indirectly ionizing radiation, which includes neutrons, gamma rays, and x-rays, is categorized separately from directly ionizing radiation, which involves charged particles. Different radiation shielding materials are better suited for certain types of radiation than others, as determined by the interaction between specific particles and the elemental properties of the shielding material.

Radiation shielding is based on the principle of attenuation, which is the ability to reduce a wave's or ray's effect by blocking or bouncing particles through a barrier material. Charged particles may be attenuated by losing energy to reactions with electrons in the barrier, while x-ray and gamma radiation are attenuated through photoemission, scattering, or pair production. Neutrons can be made less harmful through a combination of elastic and inelastic scattering, and most neutron barriers are constructed with materials that encourage these processes. The main types of radiation encountered in industrial projects include: (i) Gamma and X-rays Shielding, (ii) Neutron Shielding: and (iii) Alpha and Beta Particles. Gamma and X-rays are forms of electromagnetic radiation that occur with higher energy levels than those displayed by ultraviolet or visible light. Neutrons are particles that have neither a positive nor a negative charge, and thus provide a wide range of energy and mass levels that must be blocked. Alpha particles are positively charged helium nuclei, and are relatively easy to block, while beta particles are negatively charged electrons that are more difficult to shield against.

The majority of radiation shielding technology is based on high density metals that are formed or constructed to make shielding from radiation possible. Most often, lead, tungsten, or combination of lead and tungsten and other metals are used to manufacture radiation shielding. Metal layers, however, are not sufficient to shield from neutron radiation. Instead, materials that have an abundance of hydrogen atoms are used to shield from neutron radiation. Therefore, plastic materials are typically used for this purpose. Polyethylene and polypropylene are commonly used for this purpose.

### SUMMARY OF THE INVENTION

One or more embodiments of the present invention provide a radiation shielding composite comprising (i) a first component including a copolymer including unconjugated olefin-derived units, vinyl aromatic-derived units, and conjugated diene-derived units; and (ii) a second component including a radiation-shielding metal. In various embodiments, the unconjugated olefin derived-units are ethylene-derived units. In some embodiments, the conjugated diene-derived units are butadiene-derived units. In one or more embodiments, the vinyl aromatic-derived units are styrene-derived units.

In some embodiments, the radiation shielding composite further comprises glass or carbon fibers. In some of these embodiments, the radiation shielding composite comprises one or more carbon fibers doped with lead or a heavy metal ion. In some other embodiments, the radiation shielding composite further comprises one or more glass fibers doped with lead oxide. In one or more of these embodiments, the composite is a multilayered composite with a first plurality of layers including the first component and a second plurality of layers including the second component, where the first plurality of layers alternate with the second plurality of layers. In some of these embodiments, the first component forms a matrix in which the second component is dispersed. In one or more of these embodiments, the first component is vulcanized. In various embodiments, the radiation-shielding metal has greater than 20 protons. In some of these embodiments, the metal is selected from the group consisting of lead, tantalum, and tungsten. In one or more embodiments, the second component includes a eutectic alloy that includes at least one radiation-shielding metal. In some of these embodiments, the eutectic alloy includes a mixture of lead and bismuth, a mixture of lead and tin, or a mixture of silver and copper. In some embodiments, the eutectic alloy has a melt temperature below 300° C.

Yet other embodiments of the present invention provide a method for forming a radiation shielding composite, the method comprising (i) providing a first composition that includes a copolymer, unconjugated olefin-derived units, vinyl aromatic-derived units, and conjugated diene-derived units; (ii) providing a eutectic metal alloy; and (iii) coextruding the copolymer and the eutectic metal alloy.

Still other embodiments of the present invention provide a method for forming a radiation shielding composite, the method comprising (i) providing a first composition that includes a copolymer, unconjugated olefin-derived units, vinyl aromatic-derived units, and conjugated diene-derived units; (ii) providing a radiation-shielding metal; and (iii) mixing the copolymer and the radiation-shielding metal. In one or more of these embodiments, the method further comprises the step of vulcanizing the copolymer.

### BRIEF DESCRIPTION OF THE DRAWINGS

FIG. 1 is a schematic diagram of a copolymer used to form the radiation shielding composite of the present invention.

FIG. 2 is a schematic diagram showing one way to fabricate a multilayer radiation shielding composite according to one or more embodiments of the present invention.

### DETAILED DESCRIPTION OF THE ILLUSTRATIVE EMBODIMENTS

Embodiments of the present invention are based upon the discovery of a radiation shielding composite. In one or more embodiments, the composite is a multi-layered composite with a layer including a rubber copolymer and layer including radiation-shielding metals. In one or more embodiments, the rubber copolymer is a styrene-ethylene-butadiene copolymer (SEBR) made by metal coordination chemistry. In other embodiments, the composite includes a rubber copolymer and a radiation-shielding metal dispersed therein. While radiation shielding composites that employ LDPE or PP are known, it is believed that the composites of the present invention offer greater shielding impact due to the presence of the styrene units. It is also contemplated that practice of this invention provides the ability to design and produce radiation shielding systems that use less energy and can be used for either flexible or rigid parts. Also, the radiation shielding composites of this invention may be recyclable after prolonged use.

### Rubber Copolymer

As indicated above, the composites of the present invention employ a rubber copolymer. In one or more embodiments, the rubber copolymer is a copolymer of a non-conjugated olefin monomer, a conjugated diene monomer, and a vinyl aromatic monomer; i.e. the copolymer includes mer units from a non-conjugated olefin monomer, a conjugated diene monomer, and a vinyl aromatic monomer. These rubber copolymers include multicomponent copolymers as disclosed in U.S. Publication Nos. 2020/0048380, 2020/0140576, and 2014/0031502, U.S. Pat. No. 9,273,165, and International Publication Nos. WO 2014/0555868 and WO 2014/052957, which are incorporated by reference. As used herein, mer units that derive from polymerizing a particular monomer may be referred to as monomer-derived units (e.g. ethylene-derived units).

Some useful non-conjugated olefin monomer, which may also be referred to as unconjugated olefins, include, for example, α-olefins such as ethylene, propylene, 1-butene, 1-pentene, 1-hexene, 1-heptene, 1-octene and the like.

Some useful conjugated diene monomers include, for example, 1,3-butadiene, isoprene, 1,3-pentadiene, and 2,3-dimethyl-1,3-butadiene, and combinations thereof. In one embodiment, the conjugated diene compound has 4 to 8 carbon atoms.

Some useful vinyl aromatic monomer include, for example, styrene, o-methylstyrene, m-methylstyrene, p-methylstyrene, o,p-dimethylstyrene, o-ethylstyrene, m-ethylstyrene, and p-ethylstyrene.

In one or more embodiments, the rubber copolymer may include, on a mol % basis, greater than 40, in other embodiments greater than 45, and in other embodiments greater than 50 mol % mer units from non-conjugated olefin. In these or other embodiments, the rubber copolymer may include less than 99.8, in other embodiments less than 98, in other embodiments less than 95, and in other embodiments less than 90 mol % mer units from non-conjugated olefin. In one or more embodiments, the rubber copolymer includes from about 40 to about 99.8, in other embodiments from about 45 to about 98, and in other embodiments from about 55 to about 90 mol % mer units from non-conjugated olefin. Here, as well as elsewhere in the specification and claims, individual range values can be combined to form additional non-disclosed ranges.

In one or more embodiments, the rubber copolymer may include, on a mol % basis, greater than 0.1, in other embodiments greater than 1.0, and in other embodiments greater than 3 mol % mer units from conjugated dienes. In these or other embodiments, the rubber copolymer may include less than 30, in other embodiments less than 20, in other embodiments less than 15 mol % mer units from conjugated dienes. In one or more embodiments, the rubber copolymer includes from about 0.1 to about 30, in other embodiments from about 1.0 to about 20, and in other embodiments from about 3 to about 15 mol % mer units from conjugated dienes.

In one or more embodiments, the rubber copolymer may include, on a mol % basis, greater than 0.1, in other embodiments greater than 1.0, and in other embodiments greater than 3 mol % mer units from vinyl aromatics. In these or other embodiments, the rubber copolymer may include less than 30, in other embodiments less than 20, in other embodiments less than 15 mol % mer units from vinyl aromatics. In one or more embodiments, the rubber copolymer includes from about 0.1 to about 30, in other embodiments from about 1.0 to about 20, and in other embodiments from about 3 to about 15 mol % mer units from vinyl aromatics. Here, as well as elsewhere in the specification and claims, individual range values can be combined to form additional non-disclosed ranges.

In one or more embodiments, the rubber polymer is formed by polymerizing monomer in the presence of a single-site catalyst such as a metallocene or half-metallocene catalyst. According to one or more embodiments, the conjugated diene monomer is continuously or intermittently, in divided portions, introduced to the polymerization during the course of the polymerization. In other embodiments, all of the conjugated diene may be introduced at once and/or at the beginning of the polymerization. In particular embodiments, the conjugated diene monomer is not present at the outset of polymerization. Those skilled in the art understand that the catalyst systems may include, in addition to the metallocene or half-metallocene compounds, cocatalysts such as, but not limited to, ionic compounds and aluminoxanes.

In one or more embodiments, the catalyst may be an organometallic complex catalyst or a Lanthanide complex catalyst, such as a gadolinium (Gd) catalyst. In some embodiments, for example, it is preferable to use the polymerization catalyst composition described in JP 2016-210940 A and JP 2016-128552 A, the disclosures of which are incorporated herein by reference. In some embodiments, the polymerization catalyst may be an organometallic complex catalyst as disclosed in U.S. Pat. No. 9,416,205, and International Publication Nos. WO 2014/055868 and WO 2014/052957, the disclosures of which are incorporated herein by reference. In some embodiments, the polymerization catalyst may be a lanthanide complex catalyst as disclosed in U.S. Pat. Nos. 9,273,165 and 9,469,658, the disclosures of which are incorporated herein by reference. In some embodiments, the polymerization catalyst may be a metallocene complex catalyst as disclosed in U.S. Pat. No. 9,346,907, the disclosure of which is incorporated herein by reference. An exemplary catalytic species includes ((1-benzyldimethylsilyl-3-methyl)indenyl) bis(bis(dimethylsilyl)amido) gadolinium complex 1-Benzyldimethyl-3-MethylSi]₂C₉H₅Gd [N(SiHMe₂)₂].

An exemplary polymerization can be conducted by charging a pressure-resistant stainless steel reactor with the aromatic vinyl compound (styrene), optionally adding a solution containing the conjugated diene (1,3-butadiene) and a catalyst solution, and heating the reactor to a temperature of from about 60° C. to about 80° C., and then the non-conjugated olefin (ethylene) is added under pressure. The polymerization is permitted to proceed, and then the reaction may be quenched with an isopropanol solution of 5 mass % of 2,2′-methylene-Ms (4-ethyl-6-t-butylphenol), or another suitable material. In some embodiments, the catalyst solution comprises ((1-benzyldimethylsilyl-3-methyl)indenyl) bis(bis(dimethylsilyl)amido) gadolinium complex 1-Benzyldimethyl-3-MethylSi]₂C₉H₅Gd [N(SiHMe₂)₂], dimethylanilinium tetrakis(pentafluorophenyl)borate [Me₂NHPhB(C₆F₅)₄], diisobutylaluminum hydride, and toluene. As suggested above, only a portion of the total amount of conjugated diene may be added to the reaction vessel at the beginning of the reaction, with the balance being added in divided portions during polymerization.

In one or more embodiments, the ratio of the moles of the conjugated diene compound to the moles of the polymerization catalyst, i.e. the molar ratio butadiene to moles of metal within the metallocene or half metallocene compound, may be from about 1:1 to about 1:1,000,000, in other embodiments from 1:1 to about 1:200,000, in other embodiments from about 1:1 to about 1:1000, and in other embodiments from about 1:1 to about 1:100. Here, as well as elsewhere in the specification and claims, individual range values can be combined to form additional non-disclosed ranges.

In one or more embodiments, the polymerization is conducted within a solvent. Useful solvents include, for example, toluene, cyclohexane, and n-hexane.

In those embodiments where the conjugated diene monomer is added to the reaction mixture in divided portions, the divided portions may be added in an amount of 0.1 mmol to 500 mmol each time. The conjugated diene may be added to the reaction in a suitable solvent, such as those described above with respect to the polymerization medium. In embodiments where the conjugated diene compound is added in divided portions, the concentration of the conjugated diene compound in the solution to be added may be appropriately selected, and may be, for example, 10 wt % to 100 wt %. In the case of 100 wt %, the conjugated diene compound is added alone without diluting it with a solvent. For example, it may be added as a 10 wt % to 35 wt % solution. In various embodiments, the concentration of the conjugated diene compound to be added may be constant at each time, or may be different at each time the conjugated diene compound is added to the reaction vessel. In the case where the concentration of the conjugated diene compound to be added is different at each time, the concentration of the conjugated diene compound solution may vary from a low concentration to a high concentration or from a high concentration to a low concentration as the polymerization time increases,

The time for adding the conjugated diene compound in divided portions may also be appropriately adjusted. For example, it may be 5 minutes or more, or in other embodiments from 1 minute to 100 hours in total, or 1 hour to 10 hours in total. Likewise, the number of times of additions may be appropriately adjusted. For example, it may be 2 or more, 5 or more, 30 or more, or 60 or more, and 1000 or less, 60 or less, 10 or less, or 5 or less.

In one or more embodiments, the rubber copolymer may be characterized by a weight-average molecular weight (Mw) of from about 10 to about 10,000, in other embodiments from about 100 to about 5,000, in other embodiments from about 150 to about 1, 000 kg/mol. In these or other embodiments, the rubber copolymer is characterized by a Mw of greater than 10, in other embodiments greater than 10, in other embodiments greater than 150, and in other embodiments greater than 250 kg/mol. Here, as well as elsewhere in the specification and claims, individual range values can be combined to form additional non-disclosed ranges.

In one or more embodiments, the rubber copolymer may be characterized by a number-average molecular weight (Mn) of from about 10 to about 10,000, in other embodiments from about 100 to about 5,000, in other embodiments from about 150 to about 1, 000 kg/mol. In these or other embodiments, the rubber copolymer is characterized by a Mn of greater than 10, in other embodiments greater than 100, in other embodiments greater than 150, and in other embodiments greater than 250 kg/mol. Here, as well as elsewhere in the specification and claims, individual range values can be combined to form additional non-disclosed ranges.

In one or more embodiments, the rubber copolymer may be characterized by a molecular weight distribution (Mw/Mn) of 10.0 or less, or 8.0 or less, or 5 or less, or 3 or less. Here, as well as elsewhere in the specification and claims, individual range values can be combined to form additional non-disclosed ranges.

As used herein, molecular weight moments, i.e. peak molecular weight (Mp). weight-average molecular weight (Mw), and number-average molecular weight (Mn) is determined by gel permeation chromatography (GPC) using polystyrene as a standard substance.

In one or more embodiments, the rubber copolymers may be characterized by an endothermic peak energy, as measured by a differential scanning calorimeter (DSC) at 0° C. to 120°° C., of about 10 J/g to about 150 |/g, and in other embodiments from about 30 J/g to about 120 J/g. Here, as well as elsewhere in the specification and claims, individual range values can be combined to form additional non-disclosed ranges. The endothermic peak energy herein is a value measured by DSC measurement by raising the temperature from −150° C. to 150° C. at a heating rate of 10° C./min in accordance with JIS K 7121-1987 and taking the endothermic peak (enthalpy relaxation) during 0° C. to 100° C.

In one or more embodiments, the rubber copolymers may be characterized by a melting point, as measured by a differential scanning calorimeter (DSC), of from about 0° C. to about 300° C., in other embodiments from about 5° C. to about 250° C., in other embodiments from about 10° C. to about 200° C., in other embodiments from about 15° C. to about 150° C., and in other embodiments from about 20° C. to about 130° C. Here, as well as elsewhere in the specification and claims, individual range values can be combined to form additional non-disclosed ranges.

In various embodiments, the rubber copolymers may be characterized by a glass transition temperature (T_{g}), as measured by a differential scanning calorimeter (DSC) of less than 0° C., in other embodiments less than −5° C., in other embodiments less than −10° C., in other embodiments less than −15° C., in other embodiments less than −20° C., and in other embodiments less than −30° C.

In one or more embodiments, the rubber copolymers may be characterized by a glass transition temperature (T_{g}), as measured by a differential scanning calorimeter (DSC) of greater than −80° C., in other embodiments greater than −60° C., in other embodiments greater than −40° C., in other embodiments greater than −30° C., in other embodiments greater than −25° C., and in other embodiments greater than −20° C.

In one or more embodiments, the rubber copolymers may be characterized by a glass transition temperature (T_{g}), as measured by a differential scanning calorimeter (DSC), of from about −80° C. to about 0° C., in other embodiments from about −60° C. to about −5° C., in other embodiments from about −40° C. to about −10° C., and in other embodiments from about −30° C. to about −15° C. Here, as well as elsewhere in the specification and claims, individual range values can be combined to form additional non-disclosed ranges.

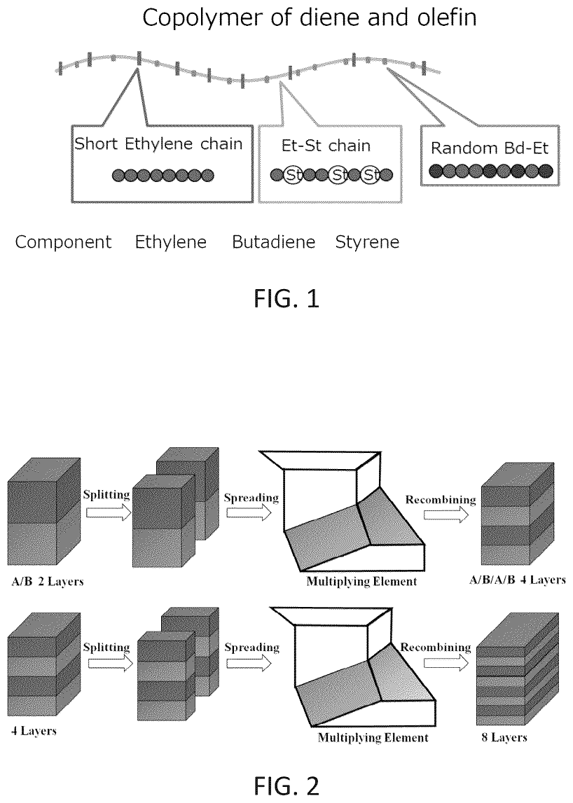

In various embodiments, the arrangement of the conjugated diene unit, the non-conjugated olefin unit, and the aromatic vinyl unit in the multicomponent copolymer is not particularly limited, and may be, for example, random, block, or graft. The structure of the rubber copolymer employed in one or more embodiments of the present invention can be described with reference to FIG. 1, which shows copolymer chain including a plurality of short ethylene chain segments, a plurality of ethylene-styrene chain segments, and a plurality of ethylene-butadiene chain segments.

### Radiation-Shielding Metals

In one or more embodiments, the radiation-shielding metals include metals with high atomic number of protons within the nucleus. As the skilled person will appreciate, these metals are often referred to as high-Z materials or metals. In one or more embodiments, the high-Z materials have 22 or more, in other embodiments 40 or more, and in other embodiments 72 or more protons. Exemplary high Z materials that may be used in the present invention include lead (Pb), tantalum (Ta), and tungsten (W). The high-Z materials may be used individually or as a mixture or alloy of two more metals.

In one or more embodiments, the radiation-shielding metal is included within a eutectic mixture. In various embodiments, this may include a eutectic mixture of two high-Z metals. In other embodiments, the mixture may include a mixture of one high-Z metal and another metal that is not considered a high-Z metal. The eutectic mixture may include binary, tertiary or multicomponent mixtures. As the skilled person appreciates, eutectic mixtures, which may also be referred to as eutectic alloys, exhibit a melting temperature that is lower than the melting temperature of the constituent metals. In some embodiments, exemplary eutectic alloys include a mixture of lead (Pb) and bismuth (Bi), in other embodiments a mixture of lead (Pb) and tin (Sn), and in other embodiments a mixture of silver (Ag) and copper (Cu).

In one or more embodiments, the radiation-shielding metal, which may include a eutectic mixture of metals, has a melt temperature below 300° C., in other embodiments below 250° C., in other embodiments below 200° C., in other embodiments below 180° C., in other embodiments below 150° C., and in other embodiments below 130° C.

### Other Constituents

On one or more embodiments, the composites of the present invention may also include filler materials dispersed within the rubber polymer. Exemplary filler materials include, but are not limited to, carbon fibers and glass fibers. Carbon fiber used in this type of composite could be doped with lead or other heavy metal ions to increase ability to scatter or elastically interact with ionizing radiation. Analogously, glass fiber could be used for the composite. It is also known that glass doped or mixed with lead oxide provides increased radiation shielding. Thus, using fiber drawn from this type of glass would allow to create high strength, light weight (compared to a metal layer) radiation shielding material able to attenuate all three major types of ionizing radiation.

### Composite Structure

As indicated above, the radiation shielding composite may include a layered structure with a first layer including the rubber copolymer and a second layer including radiation-shielding metals. In one or more embodiments, these radiation shielding composites are multi-layered with alternating layers of the rubber copolymer and radiation-shielding metals described above. In one or more embodiments, the radiation shielding composite includes from about 2 to about 100, in other embodiments from about 4 to about 80, in other embodiments from about 6 to about 60, in other embodiments, from about 8 to about 40, and in other embodiments from about 10 to about 30 alternating layers. In these or other embodiments, the composites include greater than 2, in other embodiments greater than 10, in other embodiments greater than 20, in other embodiments greater than 30, in other embodiments greater than 40 and in other embodiments greater than 50 alternating layers.

In one or more embodiments, the individual layers of the composite (i.e. the rubber polymer layer and the metal layer) may each respectively have a thickness of from about 10 to about 1000 μm, in other embodiments from about 20 to about 800 μm, in other embodiments from about 30 to about 500 μm, and in other embodiments from about 50 to about 250 μm. In one or more embodiments, the respective layers have a thickness of greater than 10 μm, in other embodiments greater than 30 μm, in other embodiments greater than 50 μm, in other embodiments greater than 80 μm, in other embodiments greater than 100 μm. In these or other embodiments, the respective layers have a thickness of less than 2500 μm, in other embodiments less than 1500 μm, in other embodiments less than 1000 μm, in other embodiments less than 700 μm, in other embodiments less than 500 μm, in other embodiments less than 250 μm. Here, as well as elsewhere in the specification and claims, individual range values can be combined to form additional non-disclosed ranges.

In one or more embodiments, the multi-layered composites can be formed by co-extrusion techniques. Advantageously, practice of the present invention provides the ability to co-extrude the materials since the melt temperatures of the respective materials (i.e. the melt temperatures of the rubber copolymer and the metal alloy) can generally be aligned given the use of a eutectic alloy, which allows the melt temperature of the metal to be lower than the constituent metals. Also, bond and/or integration of the two layers is improved.

According to these embodiments, the rubber copolymer and the metal are co-extruded to form a co-extrudate, and then the co-extrudate can undergo a splitting, spreading, and recombining technique to form a multi-layered composite. This process may be referred to as multiplication. Exemplary multipliers are described, for example, in U.S. Pat. Nos. 5,094,788 and 5,094,793, which are incorporated herein by reference. An exemplary splitting, spreading, and recombining technique can be understood from FIG. 2.

As also indicated above, in other embodiments, the radiation shielding composite includes a blend of the rubber polymer and the radiation-shielding metal. In one or more embodiments, the blend is a multi-phased blend where the rubber copolymer is a first phase and the metal is a second phase. In one or more embodiments, the rubber polymer serves as a matrix in which the radiation-shielding metal is dispersed. In other words, the rubber copolymer is a continuous phase while the metal is a discontinuous phase. This composite can then be molded and shaped as desired.

According to these embodiments, the rubber copolymer and radiation-shielding metals, as well as any other constituents, can be combined within a mixing device and mixed at elevated temperatures such as temperatures at or near the melt temperature of the rubber copolymer and/or metal alloy. In one or more embodiments, mixing takes place above the melt temperature of the rubber copolymer and the metal alloy. In one or more embodiments, mixing takes place within a reaction extruder such as a twin-screw or planetary extruder. In other embodiments, mixing takes place within a batch mixer such as a Banbury or Brabender mixer.

In one or more embodiments, the blend of rubber copolymer and radiation-shielding metal includes less than 1000 parts by weight (pbw), in other embodiments less than 750, in other embodiments less than 500, in other embodiments less than 300, in other embodiments less than 200, and in other embodiments less than 150 pbw radiation-shielding metal per 100 pbw of the rubber copolymer.

In one or more embodiments, the blend of rubber copolymer and radiation-shielding metal includes greater than 1 pbw, in other embodiments greater than 10, in other embodiments greater than 20, in other embodiments greater than 30, in other embodiments greater than 50, and in other embodiments greater than 75 pbw radiation-shielding metal per 100 pbw of the rubber copolymer.

In one or more embodiments, the blend of rubber copolymer and radiation-shielding metal includes from about 1 to about 1000 pbw, in other embodiments from about 10 to about 750, in other embodiments from about 20 to about 500, in other embodiments from about 30 to about 300, in other embodiments from about 50 to about 200, and in other embodiments from about 75 to about 150 pbw radiation-shielding metal per 100 pbw of the rubber copolymer. Here, as well as elsewhere in the specification and claims, individual range values can be combined to form additional non-disclosed ranges.

In one or more embodiments, the blend of rubber copolymer and radiation-shielding metal includes less than 200 parts by volume (pbv), in other embodiments less than 150, in other embodiments less than 125, in other embodiments less than 100, and in other embodiments less than 75 pbv radiation-shielding metal per 100 pbv of the rubber copolymer.

In one or more embodiments, the blend of rubber copolymer and radiation-shielding metal includes greater than 1 pbv, in other embodiments greater than 10, in other embodiments greater than 20, in other embodiments greater than 30, and in other embodiments greater than 50 pbv radiation-shielding metal per 100 pbv of the rubber copolymer.

In one or more embodiments, the blend of rubber copolymer and radiation-shielding metal includes from about 1 to about 200 pbv, in other embodiments from about 10 to about 150 pbv, in other embodiments from about 20 to about 125 pbv, in other embodiments from about 30 to about 100 pbv, and in other embodiments from about 50 to about 75 pbv radiation-shielding metal per 100 pbv of the rubber copolymer. Here, as well as elsewhere in the specification and claims, individual range values can be combined to form additional non-disclosed ranges.

In some other embodiments, this multilayered structure could be used further for galvanization and coating of additional a metal film on top of the polymeric layers. It is believed that his would provide increased weather stability.

### Rubber Copolymer Mixture

In one or more embodiments, the rubber copolymer may be combined with other constituents including those constituents that may be used in rubber or plastic compounding. It will be appreciated that these other constituents will be included with the rubber copolymer layer of layered composites, as described above, or within the mixture where the rubber copolymer and radiation-shielding metals are combined. In the latter embodiments, the other constituents may be dispersed with the radiation-shielding metals or they may be co-continuous with the polymeric matrix, depending on the nature of the other constituents.

In one or more embodiments, the rubber copolymer is combined with a complementary polymer such as a complementary rubber polymer. Examples of these rubbers include, without limitation, a natural rubber, a butadiene rubber, a styrene-butadiene copolymer rubber, an isoprene rubber, a butyl rubber, a bromide of a copolymer of isobutylene and p-methylstyrene, a halogenated butyl rubber, an acrylonitrile-butadiene rubber, a chloroprene rubber, an ethylene-propylene copolymer rubber, an ethylene-propylene-diene copolymer rubber, a styrene-isoprene copolymer rubber, a styrene-isoprene-butadiene copolymer rubber, an isoprene-butadiene copolymer rubber, chlorosulfonated polyethylene, an acrylic rubber, an epichlorohydrin rubber, a polysulfide rubber, a silicone rubber, a fluororubber, and a urethane rubber. These other rubber components may be used alone or in a combination of two or more.

In these or other embodiments, the rubber copolymer may be combined with other fillers, a crosslinking agent, a vulcanization accelerator, an age resistor, a reinforcing agent, a softening agent, a vulcanizing co-agent, a colorant, a flame retardant, a lubricant, a foaming agent, a plasticizer, a processing ald, an antioxidant, an anti-scorch agent, an ultraviolet rays protecting agent, an antistatic agent, a color protecting agent, and oil. Each additive may be used alone or in a combination of two or more.

In one or more embodiments, the filler is not particularly limited, and may be any known filler. Examples thereof include carbon black, silica, aluminum hydroxide, clay, alumina, talc, mica, kaolin, glass balloon, glass beads, calcium carbonate, magnesium carbonate, magnesium hydroxide, magnesium oxide, titanium oxide, potassium titanate, and barium sulfate. It will be appreciated that the filler may be used alone or in a combination of two or more

In particular embodiments, carbon black is included. Examples of the carbon black include FEF, GPF, SRF, HAF, N339, IISAF, ISAF, and SAF. The nitrogen absorption specific surface area (N2SA, measured according to JIS K 6217-2:2001) for the rubber/resin hybrid multicomponent copolymer material is not particularly limited and may be appropriately selected depending on the intended use. For example, N₂SA may be 20 m²/g or more or 35 m²/g or more, and 200 m²/g or less or 100 m²/g or less.

In one or more embodiments, the rubber copolymer composition may include from about 1 to about 1000 parts by weight, in other embodiments from about 10 to about 500, in other embodiments from about 20 to about 250, and in other embodiments from about 30 to about 150 parts by weight filler, other than the radiation-shielding metal, per 100 parts by weight of the rubber copolymer. Here, as well as elsewhere in the specification and claims, individual range values can be combined to form additional non-disclosed ranges.

### Vulcanized Composites

In one or more embodiments, the rubber copolymer is crosslinked, which may also be referred to as vulcanized, to provide a cured or vulcanized composite. It will be appreciated that where the composite includes a layered structure, the radiation-shielding metal layers will be disposed between vulcanized layers of the rubber copolymer, and where the radiation-shielding metal is dispersed within a matrix of the rubber copolymer, the radiation-shielding metal will be dispersed within a cured matrix of the rubber copolymer.

Crosslinking (i.e. vulcanization) of the rubber copolymer, as well as any complementary rubber polymers within the rubber composition, can take place by including a crosslinking agent, which may also be referred to as vulcanizing agent, into the rubber composition, and then subjecting the composite to vulcanization conditions.

Examples of useful crosslinking agents include sulfur-based crosslinking agents, an organic peroxide-based crosslinking agent, an inorganic crosslinking agent, a polyamine crosslinking agent, a resin crosslinking agent, a sulfur compound-based crosslinking agent, and an oxime-nitrosamine-based crosslinking agent. Similarly, the content of the crosslinking agent in the rubber composition is not particularly limited, and may be appropriately selected depending on the intended use. For example, the content may be 0.1 parts by mass to 20 parts by mass with respect to 100 parts by mass of the rubber component.

In the case of using a sulfur-based crosslinking agent (vulcanizing agent), a vulcanization accelerator may also be used. Examples of the vulcanization accelerator include a guanidine-based compound, an aldehyde-amine-based compound, an aldehyde-ammonia-based compound, a thiazole-based compound, a sulfenamide-based compound, a thiourea-based compound, a thiuram-based compound, a dithiocarbamate-based compound, and a xanthate-based compound.

In one or more embodiments, crosslinking takes place after formation of the composite. For example, a layered composite may be formed or a molded structure may be formed from a mixture, and then the multi-layered composite to composite formed from a mixture is subjected to curing conditions. In one or more embodiments, curing conditions may include subjecting the pre-cured composite to elevated temperatures. For example, the pre-cured composite may be heated to a temperature of from about 120° C. to about 300° C., or in other embodiments from about 150° C. to about 250° C., for from about 1 to about 900 minutes, or in other embodiments from about 15 to about 300 minutes.

In light of the foregoing, it should be appreciated that the present invention significantly advances the art by providing a radiation shielding material that is structurally and functionally improved in a number of ways. While particular embodiments of the invention have been disclosed in detail herein, it should be appreciated that the invention is not limited thereto or thereby inasmuch as variations on the invention herein will be readily appreciated by those of ordinary skill in the art. The scope of the invention shall be appreciated from the claims that follow.

Various modifications and alterations that do not depart from the scope and spirit of this invention will become apparent to those skilled in the art. This invention is not to be duly limited to the illustrative embodiments set forth herein.

What is claimed is:

1. A radiation shielding composite comprising:
(i) a first component including a copolymer including unconjugated olefin-derived units, vinyl aromatic-derived units, and conjugated diene-derived units; and
(ii) a second component including a radiation-shielding metal.

2. The radiation shielding composite of claim 1, wherein the unconjugated olefin derived-units are ethylene-derived units.

3. The radiation shielding composite of claim 1, wherein the conjugated diene-derived units are butadiene-derived units.

4. The radiation shielding composite of claim 1, wherein the vinyl aromatic-derived units are styrene-derived units.

5. The radiation shielding composite of claim 1, further comprising glass or carbon fibers.

6. The radiation shielding composite of claim 1, wherein said radiation shielding composite further comprises one or more carbon fibers doped with lead or a heavy metal ion.

7. The radiation shielding composite of claim 1, wherein said radiation shielding composite further comprises one or more glass fibers doped with lead oxide.

8. The radiation shielding composite of claim 1, where the composite is a multilayered composite with a first plurality of layers including the first component and a second plurality of layers including the second component, where the first plurality of layers alternate with the second plurality of layers.

9. The radiation shielding composite of claim 1, where the composite is a multi-phased blend, where the first component forms a matrix in which the second component is dispersed.

10. The radiation shielding composite of claim 1, where the radiation-shielding metal has greater than 20 protons.

11. The radiation shielding composite of claim 10, where the metal is selected from the group consisting of lead, tantalum, and tungsten.

12. The radiation shielding composite of claim 1, where the second component includes a eutectic alloy that includes at least one radiation-shielding metal.

13. The radiation shielding composite of claim 12, where the eutectic alloy includes a mixture of lead and bismuth, a mixture of lead and tin, or a mixture of silver and copper.

14. The radiation shielding composite of claim 12, where the eutectic alloy has a melt temperature below 300° C.

15. The radiation shielding composite of claim 1, where said first component is vulcanized.

16. A method for forming a radiation shielding composite, the method comprising:
(i) providing a first composition that includes a copolymer including unconjugated olefin-derived units, vinyl aromatic-derived units, and conjugated diene-derived units;
(ii) providing a eutectic metal alloy; and
(iii) coextruding the copolymer and the eutectic metal alloy.

17. A method for forming a radiation shielding composite, the method comprising:
(i) providing a first composition that includes a copolymer including unconjugated olefin-derived units, vinyl aromatic-derived units, and conjugated diene-derived units;
(ii) providing a radiation-shielding metal; and
(iii) mixing the copolymer and the radiation-shielding metal.

18. The method of claim 17, further comprising the step of vulcanizing the copolymer.
